(19) United States
(12) Patent Application Publication
(10) Pub. No.: US 2007/0028180 A1
(43) Pub. Date: Feb. 1, 2007

(54) Tab order management in a portal environment

(75) Inventors: Laquicia S. Barbee, Durham, NC (US); Ryan A. Boyles, Wake Forest, NC (US); Jason C. Plurad, Raleigh, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/189,191

(22) Filed: Jul. 26, 2005

(51) Int. Cl. G06F 3/00; G06F 17/00

(52) U.S. Cl. 715/764; 715/777; 715/517; 715/513

(57) ABSTRACT

Embodiments of the present invention address deficiencies of the art in respect to managing tabbing order in a portal environment and provide a novel and non-obvious method, system and computer program product for tab order management for portlets in a portal environment. In a first embodiment, a tab order management data processing system can include a portal server configured to render a portal page, a portlet aggregator configured to provide portlet markup for different portlets in the portal page, and tab order management logic coupled to the portlet aggregator. The tab order management logic can be configured to transform a relative tab order for tabbed elements in each of the different portlets into a single tab order for the portal page. For instance, the tab order management logic can include a configuration to transform relative indices for the tabbed elements in each of the different portlets into a single index for the portal page.

### BACKGROUND OF THE INVENTION

1. Field of the Invention

The present invention relates to tab order management of controls in a markup language environment and more particularly to the management of tab ordering in a portal environment.

2. Description of the Related Art

Distributing content about large computer communications networks is not without its challenges. In particular, the quantity of content available for distribution in a computer communications network often varies proportionally to the size of the computer communications network. At the extreme, the Internet hosts a vast quantity of content not easily accessible by most end-users. Portals represent a sensible solution to the problem of aggregating content through a channel paradigm in a single, network-addressable location. In consequence, portals have become the rage in content distribution.

Portlets are the visible active components included as part of portal pages. Similar to the graphical windows paradigm of windowing operating systems, each portlet in a portal occupies a portion of the portal page through which the portlet can display associated content from a portlet channel. Portlets are known to include both simple applications such as an electronic mail client, and also more complex applications such as forecasting output from a customer relationship management system. The prototypical portlet can be implemented as server-side scripts executed through a portal server.

From the end-user perspective, a portlet is a content channel or application to which the end-user can subscribe. By comparison, from the perspective of the content provider, a portlet is a means through which content can be distributed in a personalized manner to a subscribing end-user. Finally, from the point of view of the portal, a portlet merely is a component which can be rendered within the portal page. In any case, by providing one or more individually selectable and configurable portlets in a portal, portal providers can distribute content and applications through a unified interface in a personalized manner according to the preferences of the end-user.

Portal servers are computer programs which facilitate the distribution of portal based Web sites on the public Internet or a private intranet. Importantly, it will be recognized by one of ordinary skill in the art that the signature characteristic of all conventional portal servers can include the aggregation of content from several portlet applications within a single distributable page in a uniform manner. To that end, each portlet application within the portal page can be represented by a portlet user interface distributed by the portal server to requesting client computing devices.

The aggregation of content from several portlet applications within a single distributable page in a uniform manner can present unique challenges in crafting a navigable user interface. Specifically, in an ordinary user interface, setting the tabbing order for navigating between elements in the user interface can be a matter of establishing the tabbing order through an indexing scheme. In a portal environment, however, the indexing scheme of any one portlet can conflict with the indexing scheme of the other portlets. Moreover, unlike a conventional user interface which usually is within the control of a single person or team of persons, in a portal environment, literally each portlet can be within the control of different persons. Accordingly, it will not be reasonable to expect coordination among the different persons in establishing a proper tabbing order for elements in each portlet.

### BRIEF SUMMARY OF THE INVENTION

Embodiments of the present invention address deficiencies of the art in respect to managing tabbing order in a portal environment and provide a novel and non-obvious method, system and computer program product for tab order management for portlets in a portal environment. In a first embodiment, a tab order management data processing system can include a portal server configured to render a portal page, a portlet aggregator configured to provide portlet markup for different portlets in the portal page, and tab order management logic coupled to the portlet aggregator. The tab order management logic can be configured to transform a relative tab order for tabbed elements in each of the different portlets into a single tab order for the portal page. For instance, the tab order management logic can include a configuration to transform relative indices for the tabbed elements in each of the different portlets into a single index for the portal page.

In another embodiment, a tab order management method can include transforming a relative tab order for tabbed elements in each of different portlets into a single tab order for a portal page in a portal environment. For example, transforming a relative tab order for tabbed elements in each of different portlets into a single tab order for a portal page in a portal environment, can include transforming each relative index value for a relative index for tabbed elements in a portlet into an absolute index value for a uniform index for the portal page. More specifically, transforming a relative tab order for tabbed elements in each of different portlets into a single tab order for a portal page in a portal environment, selecting a portlet in the portal page, adding a current index value for a uniform index for the portal page to each relative index value for each tabbed element in the selected portlet to produce a uniform index value for the tabbed element, changing the current index value to a value accounting for a last processed tabbed element in the selected portlet, and repeating the retrieving and adding for each additional portlet in the portal page.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a portal environment data processing system configured for tab order management; and,

FIG. 2 is a flow chart illustrating a process for tab order management in a portal environment.

### DETAILED DESCRIPTION OF THE INVENTION

Embodiments of the present invention provide a method, system and computer program product for tab order management in a portal environment. In accordance with an embodiment of the present invention, the tab order for elements within different portlets in the portal environment can be unified into a single sequence. Specifically, the sequence of display of the portlets in the portal environment can be used to transform the relative ordering of elements within each portlet into a single ordering of elements in the portal display. In this way, conflicting indexing schemes for the different portlets can be unified in the portal display.

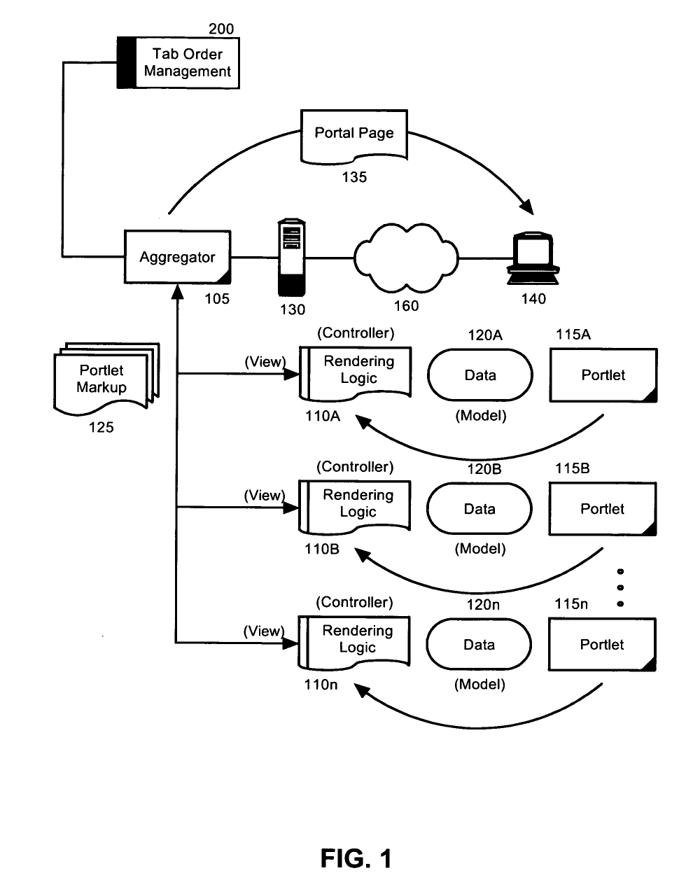

In more particular illustration, FIG. 1 is a schematic illustration of a portal environment data processing system configured for tab order management. The portal environment data processing system can include a portal page 135 communicatively coupled to a selection of portlet applications 115A, 115B, 115n through a portal server 130. Each portlet application 115A, 115B, 115n can produce a view based upon portlet data 120A, 120B, 120n in the form of portlet markup 125 through corresponding rendering logic 110A, 110B, 110n. Notably, the rendering logic 110A, 110B, 110n can be active markup such as a JSP, in which logical scriptlets can be embedded to produce specific markup language tags.

A portlet aggregator 105 can be coupled to each portlet application 115A, 115B, 115n to receive the portlet markup 125 and to aggregate the portlet markup 125 into view in the portal page 135. By aggregation, it is meant that the individual markup language blocks produced by each portlet 115A, 115B, 115n can be combined into a single cohesive markup language document configured for distribution to and use within a conventional content browser. In this regard, the portal page 135 can be disposed in the portal server 130 from which the portal 135 can be accessed by client content browsing devices 140 over a computer communications network 160 such as a local computer communications network, for instance a private intranet, or a global computer communications network, for instance the public Internet.

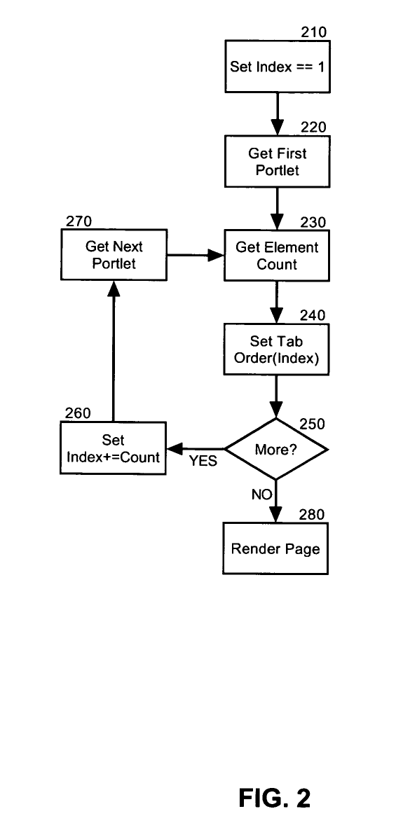

Notably, tab order management logic 200 can be coupled to the aggregator 105. The tab order management logic 200 can be configured to transform the relative tab order indices of each tabbed element in each portlet 115B into a single, unified tab order index. In more particular illustration, FIG. 2 is a flow chart illustrating a process for tab order management in a portal environment. Beginning in block 210, an index for the portal display can be set to an initial value. In block 220, a first portlet can be selected for processing. In block 230, the number of tabbed elements in the selected portlet can be counted. Specifically, each element which permits tabbed navigation can be counted to determine a number of elements which can be navigated through the activation of a tab operation.

In block 240, the relative tab order for the selected portlet can be transformed into a uniform tab order for the portal page in which the portlet is to be displayed. In this regard, the transformation of the relative tab order for the selected portlet can account for the order of the portlets in the portal display and the number of tabbed elements already sequenced for other portlets. Specifically, for n processed portlets having m tabbed elements among the n processed portlets, the index of the first tabbed element in the n+1 portlet having x tabbed elements will be m+1 and the index of the last tabbed element in the n+1 portlet will be n+x.

Hence, in block 240, the relative index for each tabbed element in the selected portlet can be transformed to a uniform index having a value resulting from the addition of the relative index value and the current index value for the portal display. Subsequently, in decision block 250, if additional portlets remain to be processed, in block 260, the current index value for the portal display can be set to the transformed index value for the last tabbed element in the selected portlet. Thereafter, the next portlet can be retrieved in block 270 and the process can continue through block 230. When no further portlets remain to be processed, the transformation process can end and the portal display can be rendered in block 280.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A tab order management data processing system comprising:
a portal server configured to render a portal page;
a portlet aggregator configured to provide portlet markup for different portlets in said portal page; and,
tab order management logic coupled to said portlet aggregator and configured to transform a relative tab order for tabbed elements in each of said different portlets into a single tab order for said portal page.

2. The data processing system of claim 1, wherein said tab order management logic comprises a configuration to transform relative indices for said tabbed elements in each of said different portlets into a single index for said portal page.

3. A tab order management method comprising transforming a relative tab order for tabbed elements in each of different portlets into a single tab order for a portal page in a portal environment.

4. The method of claim 3, wherein said transforming a relative tab order for tabbed elements in each of different portlets into a single tab order for a portal page in a portal environment, comprises transforming each relative index value for a relative index for tabbed elements in a portlet into an absolute index value for a uniform index for said portal page.

5. The method of claim 3, wherein said transforming a relative tab order for tabbed elements in each of different portlets into a single tab order for a portal page in a portal environment, comprises:
selecting a portlet in said portal page;
adding a current index value for a uniform index for said portal page to each relative index value for each tabbed element in said selected portlet to produce a uniform index value for said tabbed element;
changing said current index value to a value accounting for a last processed tabbed element in said selected portlet; and,
repeating said retrieving and adding for each additional portlet in said portal page.

6. A computer program product comprising a computer usable medium having computer usable program code for tab order management in a portal environment, said computer program product including computer usable program code for transforming a relative tab order for tabbed elements in each of different portlets into a single tab order for a portal page in a portal environment.

7. The computer program product of claim 6, wherein said computer usable program code for transforming a relative tab order for tabbed elements in each of different portlets into a single tab order for a portal page in a portal environment, comprises computer usable program code for transforming each relative index value for a relative index for tabbed elements in a portlet into an absolute index value for a uniform index for said portal page.

8. The computer program product of claim 6, wherein said computer usable program code for transforming a relative tab order for tabbed elements in each of different portlets into a single tab order for a portal page in a portal environment, comprises:
computer usable program code for selecting a portlet in said portal page;
computer usable program code for adding a current index value for a uniform index for said portal page to each relative index value for each tabbed element in said selected portlet to produce a uniform index value for said tabbed element;
computer usable program code for changing said current index value to a value accounting for a last processed tabbed element in said selected portlet; and,
computer usable program code for repeating said retrieving and adding for each additional portlet in said portal page.
